(19) United States
(12) Patent Application Publication
(10) Pub. No.: US 2015/0018059 A1
(43) Pub. Date: Jan. 15, 2015

(54) Online Mahjong Game

(71) Applicant: Yaowen CHEN, Richmond Hill (CA)

(72) Inventor: Yaowen CHEN, Richmond Hill (CA)

(21) Appl. No.: 13/941,866

(22) Filed: Jul. 15, 2013

(51) Int. Cl. A63F 13/00

(52) U.S. Cl. CPC A63F 13/00
USPC 463/9

(57) ABSTRACT

An online mahjong gaming system for a plurality of users each has a game client communicating with a game server. The game client displays a mahjong table having four player positions, a deck of turned down mahjong tiles and a row of turned up mahjong tiles visible to the user at each player position but concealed from the other users. The mahjong table has a display portion displaying turned up mahjong tiles which have been discarded. The game client displays an allow icon to the user at the player position indicating that a viewer desires to view the game. The game server is configured to link the game client of the viewer to the mahjong table to display the mahjong table to the viewer with the row of turned up mahjong tiles of the player who selected the allow icon being displayed to the viewer.

### FIELD OF THE INVENTION

The invention relates generally to online computer games for mahjong.

### BACKGROUND OF THE INVENTION

Online gaming is a booming industry since last decade, from Europe to China, from casual gaming to wagering, with massive number of players playing a variety of types of games.

Mahjong, a tradition game originated from ancient China, it involves skills, strategy and calculation. On land base, Mahjong game has gained massive popularity especially in China, also there're Mahjong associations or clubs around the world representing western players and overseas Chinese as well. The estimation of world population of Mahjong players reaches 98 million. There're 2 major set of rules for tournament playing, one is made official by Chinese government, and the other is slight variant adopted by WSOM (World serial of Mahjong). Besides, in China, Japan, Taiwan and Hong Kong, hundreds localized variant rules are played by different group of players from different regions every day.

Given the popularity of Mahjong game on land base, online community is far from well developed given the example of online poker. There are following major causes from observation:

1. Existing game is not developed in a way that meets player's requirements; giving the concerns like reliable gaming, collusion prevention, user playing experience, etc.

2. Most existing gaming site is built based on certain rules from specific regions, like Hong Kong rules, Taiwan rules; in one hand, it has very determined player group; while on other hands, it also limits its user base since most land base players tend to stick with their familiar rules.

The present invention related system is a fresh approach toward on-line Mahjong gaming that address the above deficiencies from existing on-line systems with following innovations targeting user experience.

### SUMMARY OF THE INVENTION

In accordance with one aspect of the present invention, there is provided an online mahjong gaming system which includes a plurality of users each having a game client communicating with a game server. The game client displays a mahjong table having four player positions to accommodate up to four users who wish to play at the mahjong table, each player position occupied by no more than one user. The mahjong table has a deck of turned down mahjong tiles and a row of turned up mahjong tiles visible to the user at each player position, the row of turned up mahjong tiles concealed from users occupying the other player positions. The mahjong table has a display portion displaying turned up mahjong tiles which have been discarded by users occupying the player positions. The game client displays an allow icon to the user at the player position indicating that a viewer desires to view the row of turned up mahjong tiles visible to the user at the player position. The game server is configured to link the game client of the viewer to the mahjong table to display the mahjong table to the viewer with the row of turned up mahjong tiles of the player who selected the allow icon being displayed to the viewer.

In accordance with another aspect of the present invention, there is provided an online mahjong gaming system as described in the previous paragraph wherein the game client is configured to allow a requesting user to send a join request to the game server to seat the requesting user at a player position at the mahjong table. The game server is configured to start a hand of mahjong at the mahjong table when at least two player positions are occupied.

In accordance with another aspect of the present invention, there is provided an online mahjong gaming system as described in the previous paragraph wherein the game server is configured to record one of the users occupying the player positions as a first winner of the hand of mahjong and exclude first winner from further play of the hand of mahjong. The game server is further configured to continue the hand of mahjong as a first sub-hand if there are at still users occupying the player positions and if there are still turned down mahjong tiles on the mahjong table, the game server being further configured to record one of the users occupying the payer positions as a second winner of the hand of mahjong and exclude the second winner from further play of the hand of mahjong. The game server is further configured to continue the hand of mahjong as a second sub-hand if there are at still users occupying the player positions and if there are still turned down mahjong tiles on the mahjong table. The game server being further configured to record one of the users occupying the player positions as a third winner of the hand of mahjong and then terminate the hand of mahjong.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a schematic view of an on-line Mahjong game system made in accordance with the present invention.

FIG. 2 is a flow chart showing the steps involved in the live watching feature of the present invention.

FIG. 3 is a flow chart showing the steps involved in the hand playing feature of the present invention using a variable number of players.

FIG. 4 is a flow chart showing the steps involved in multiple sub-hands with one shuffled deck.

FIG. 5 is a schematic view showing the image of a mahjong table projected on a game client made in accordance with the present invention.

FIG. 6 is a schematic view showing the friend selection feature of the present invention appearing on a game client.

In the drawings like characters of reference indicate corresponding parts in the different figures.

### DETAILED DESCRIPTION OF THE INVENTION

The present invention is a system and a method for facilitating on-line Mahjong games provided over an electronic network such as the Internet. In order to participate in on-line Mahjong games, a player needs to have access to an Internet service. The system of the present invention consists of a front end (Client), back end (Server) and storage (Database). Different components communicate with each other across network, including both internet and intranet.

In detail, the front end includes client software that end users directly interact with. The client software has different versions in terms of technology used to build with. i.e. there could be web version hosted inside web page, built with Flash or HTML5 or other type of rich (web) client technologies. The client could also be an application running on the user's computer (or mobile device) as a standalone application, developed with native technology depending on platforms, i.e. windows PC, Mac, Linux, iOS, Android or the like.

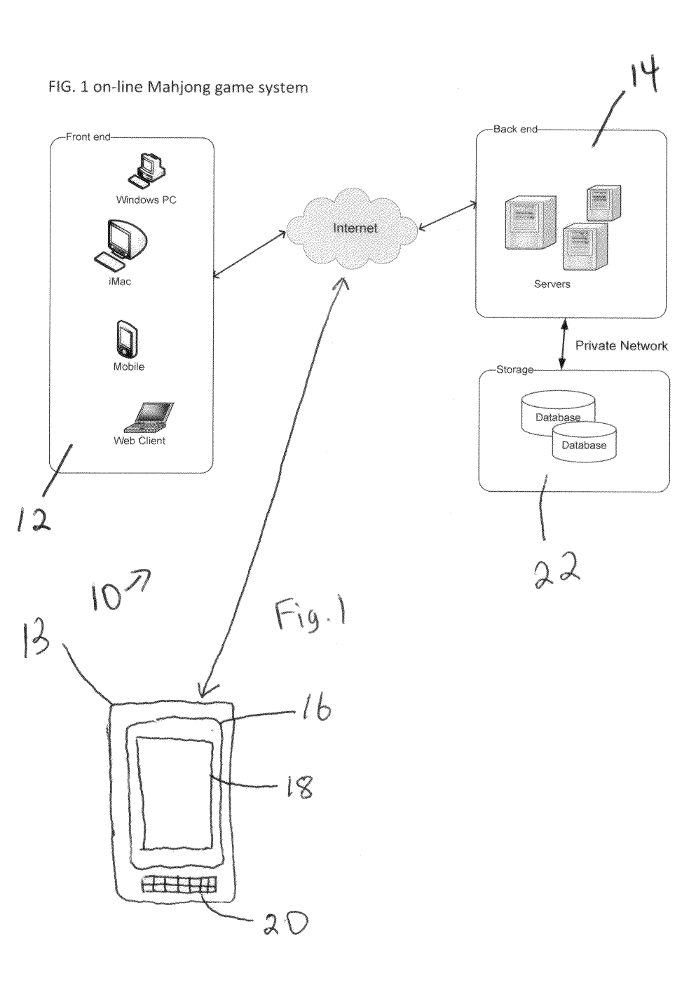

FIG. 1 shows a schematic diagram showing an on-line Mahjong game system for providing on-line Mahjong games over the Internet according to the present invention shown generally as 10. The Mahjong game system includes a plurality of terminals 12. The terminals may be personal computers, Mac computer, cell phones, tablets or any other type of computing device. Each of the terminals has Internet access to connected to back end access point game server 14. An example of a portable computing device 13 is illustrated running game client software provides a user interface UI 18 displayed on screen 16. Portable computing device 13 has the ability, by means of touch screen 16 and or keyboard 20, to allow the user to interact with the system. Client software running on computing device 13 collects user actions and send messages to back end game server 14, receives responses and events from the game server and renders messages and events on client UI 18.

Back end (Server) 14 consists of a set of software components running on a remote data centre. It accepts client connection and publishes available games and other system information, it also processes requests from game client, such requests include player login, watching game, joining game and playing game. It implements and manages the game logic, also access and store information to storage database 22. Typical and key server components include access points that host internet connections from client; game logic module that manages game play;

and information publisher that publishes game lobby information; and a data access module that interchange data to and from database 22. Storage (Database) 22 stores configuration about the System including available games, game settings and user accounts, and hand history. The database cannot be accessed directly by front end (Client). Database 22 would include information about each user, including identification information of the user (the user's name for example) and a list of other users who are friends. The game server 14 is configured to permit users to send communications (messages) back and forth to each other and to add or delete fellow users as friends.

The described on-line Mahjong game system has implemented social features among users—users can become “friends” of other users. Server 14 is able to show users if their friends are on-line, and if yes, at which tables are their friends are playing. A user can request watching their friend's hand playing with hand tile exposed, called live watching.

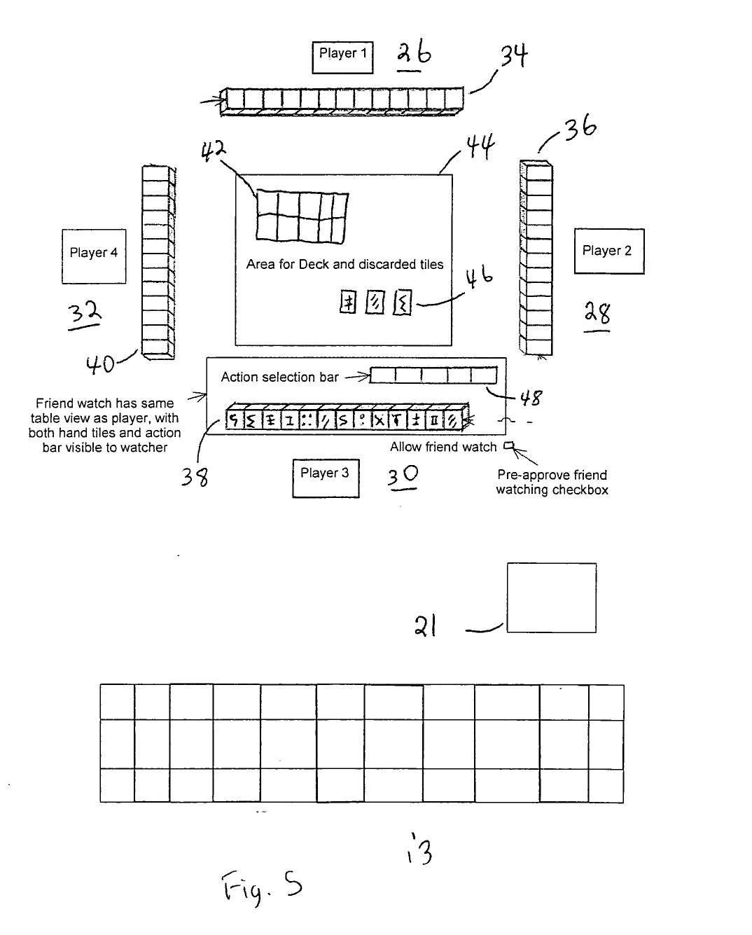

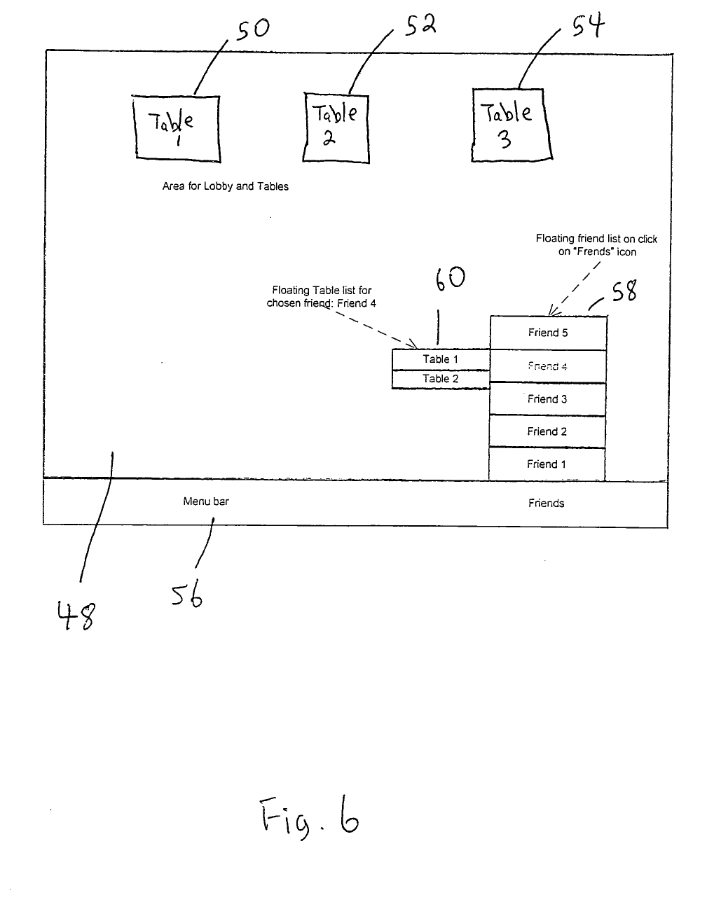

Referring now to FIG. 5, computing device 13 has the game client 21 running on the computing device. As mentioned above, game client 21 may comprise a web browser capable of displaying rich content, or it may be a separate application. Regardless of the form game client 21 takes, the game client is configured to display a virtual mahjong table 24 on screen 16. Virtual mahjong table 24 includes four player positions 26, 28, 30 and 32, each of which can be “occupied” by no more than one user, so that, when fully occupied, player 1 occupies player position 26, player 2 occupies player position 28, player 3 occupies player position 30 and player 4 occupies player position 32. Each player is a user. A plurality of mahjong tiles are shown on table 24, some of the tiles are “turned down”, meaning that the value of the tiles cannot be seen by looking at the table, while some of the tiles are “turned up”, meaning that the value of the tiles are clearly shown. A central area 44 is shown on the table adjacent the player positions. Central area 44 will show a plurality of turned down mahjong tiles arranged in a stack (or deck) 42, from which players pick tiles as a game of mahjong is played. A row of mahjong tiles is shown at each player station, representing the row of tiles (hand tiles) which the player at that player position uses to play a hand of mahjong. Hence, when four players are playing a hand of mahjong, rows 34, 36, 38 and 40 will be shown. Each row of mahjong tiles is turned down to all of the players except the player occupying the player position corresponding to the row of mahjong tiles. Therefore, taking the point of view of the user occupying player position 30, the mahjong tiles in row 38 will appear turned up, while the mahjong tiles in rows 34, 36 and 40 will appear turned down and will therefore be effectively concealed from player 3 (the user occupying player position 30). Mahjong tiles 46 which have been discarded by one or more of the players appear in area 44 as turned up tiles. In addition to the row of turned up mahjong tiles, each player position shows a plurality of icons, which can be arranged in an action selection bar 48. The user occupying player position 30 can activate one or more icons in action selection bar 48 to cause game client 21 to execute one or more commands, such as declare winning hand. Referring now to FIG. 6, the game server and game client of the present invention are also configured to provide a lobby view to a user wherein a virtual lobby 48 is displayed, upon which a plurality of different mahjong tables 50, 52 and 54 are represented. A menu bar 56 is presented to the user allowing the user to look for and find other users who are logged onto the game server. As mentioned above, some of the other users may be recorded in the database component of the system as the user's friend. The game server and game client are configured to communicate such that the game client can display a list of the user's friends 58 which are currently logged on to the game server, and a list of tables 60 where those friends are occupying player positions. From this “lobby view” the user may activate one of the icons in list 58 or 60 to send a join request to join a mahjong table as a player or to send a view or watch request to the game server to view a friend's mahjong game live.

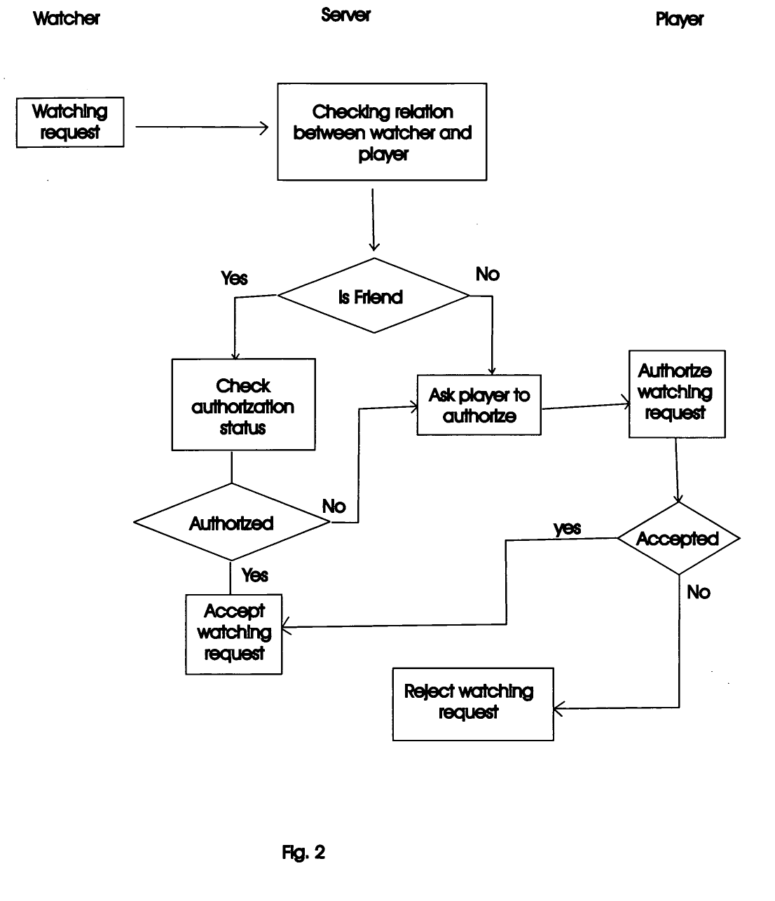

Referring now to figure FIG. 2, the process of live watching will now be discussed. Live watching is a feature of the system which allows a user who is not occupying a player position at a virtual mahjong table to view a live game of mahjong taking place on the virtual mahjong table from the point of view of one of the users occupying one of the player positions. FIG. 2 shows flow chart showing the process of live watching. A user, referred to as a watcher, sends a request to watch a player's hand. The request is accepted by the access point server and routed to the game logic server. Firstly, the game logic server checks if the watcher and requested player (the user occupying one of the player positions whom the watcher has requested to view) are friends and if the watcher has been authorized by the player. If yes, the watcher's request is granted; otherwise, the message is sent to player asking for approval of live watching. The player decides either to accept or reject the live watching request by the activation of an icon or other suitable indicia. If the user occupying the player position (i.e. the player) accepts the live watching request, the watcher would then be presented with a view of the virtual mahjong table nearly identical to the view presented to the player who was requested. In particular, the player's row of turned up mahjong tiles would be visible to the watcher. In this way, a player/user who is playing a hand of mahjong may grant other users who have been registered as friends of the player/user to view the player/user's row of mahjong tiles. The game server and game client may be further configured to permit the player and the watcher to exchange messages to each other during the playing of the hand of mahjong.

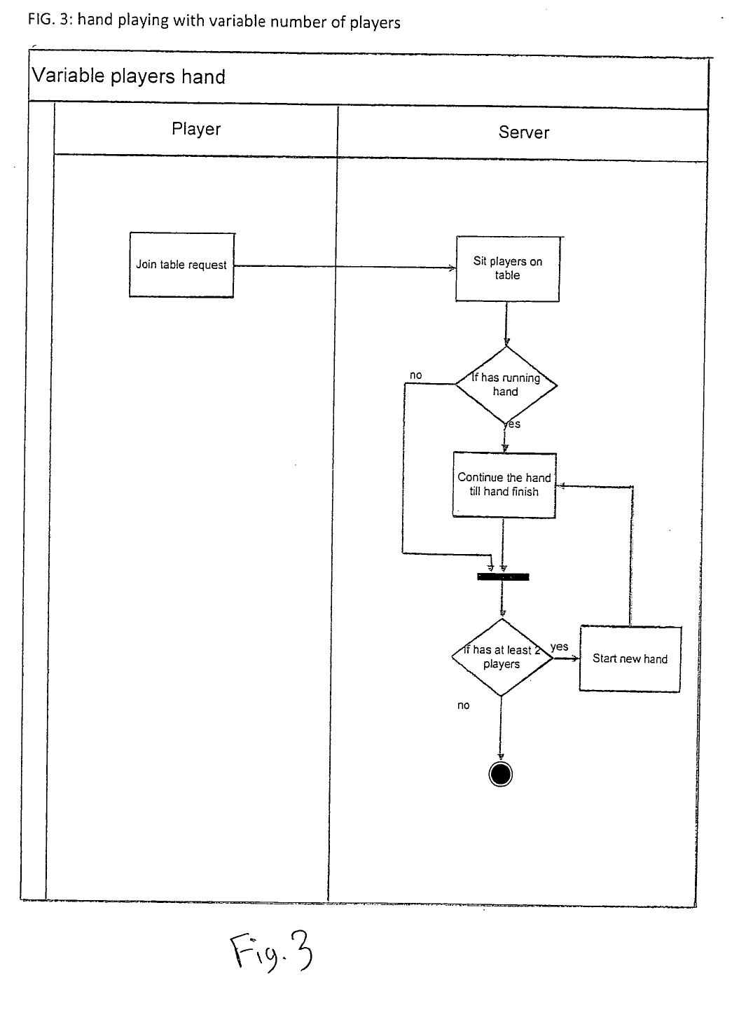

The described on-line Mahjong game system has implemented another innovative feature called “keep rolling” that allows a Mahjong hand to start without a full table. Given a typical Mahjong table with four seats (player positions), not like traditional rules which require that all four seats must be taken to start a hand, the feature allows to start a game or hand of mahjong as long as two player positions are occupied by users. Therefore, the number of players for each hand varies from two to four on the table. A new player can sit on the table anytime and join the next hand. This feature has its value particularly over an electronic network such as Internet, it starts game quickly, it also keep the continuation of game playing if one or two players left the table. As illustrated in the flowchart shown in FIG. 3, the process starts with a user requesting to “join” a table by occupying one of the player positions at the virtual mahjong table. This is done by activating a join request icon which has the effect of sending a join request from the player's game client to the game server. The game server then checks if the seat is occupied, if not, then the user is “seated” at the table (i.e. allocated a player position to occupy at the virtual mahjong table). If there is a running hand of mahjong playing, then the game server continues the hand of mahjong until it ends before “seating” the requesting player. The game server is configured to start a new hand of mahjong where there are at least two player positions at the virtual mahjong table occupied by users.

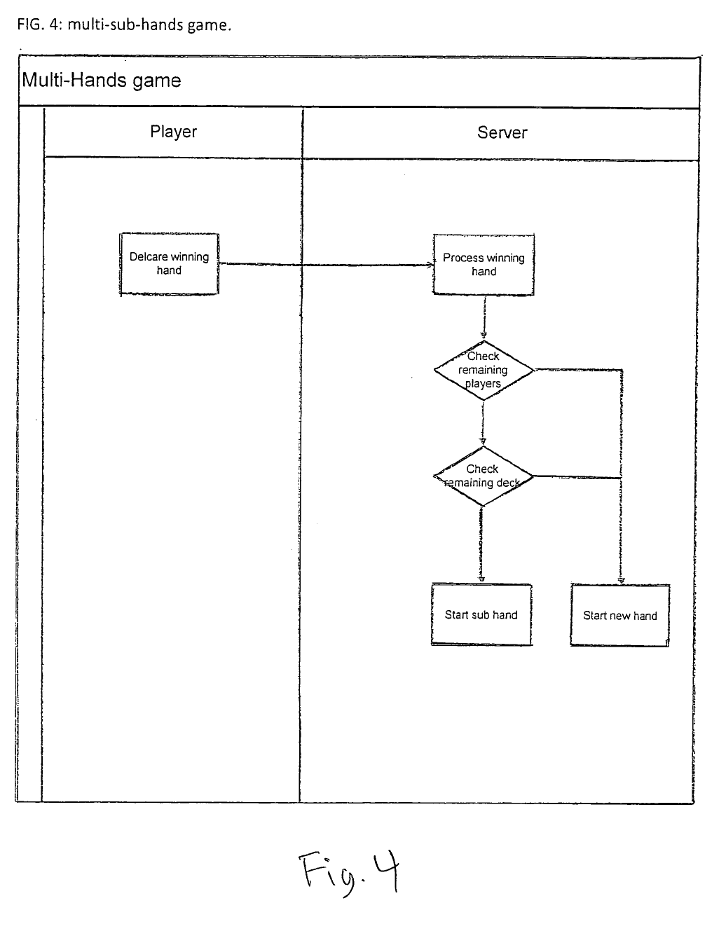

The described on-line Mahjong game system has implemented another innovative feature that supports more than one winning hands given one shuffled Mahjong deck. A Mahjong hand starts from shuffling the deck and then players start playing from taking tiles from the deck in turn till a winning hand is made. When a player makes a winning hand, the player shows down the winning hand and collects winnings from pot. As illustrated in the flowchart shown in FIG. 4, the game server is configured to declare a first winner of the hand of mahjong. With this multi-sub-hand feature, the hand will continue after a player has been declared a first winner with a winning hand, given the condition that there are at least two players remaining at the mahjong table and the shuffled deck is not exhausted (i.e. there are still turned down mahjong tiles). The game server can then start a sub-hand using the remaining mahjong tiles and the remaining players until a second mahjong winner is declared. The game server is configured to bar the first declared winner from playing the sub-hand. An addition sub-hand can be played, provided there are at least two players remaining at the mahjong table and turned down mahjong tiles remain. The additional sub-hand is played (without the participation of the first and second winners) until a final winner is declared. This way, from hand starts, there could be multiple winning hands made called sub hands. This feature encourages players to pursue winning hand with higher value, thus win bigger pot or even qualified for Jackpot winning

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. An online mahjong gaming system comprising:
a. A plurality of users each having a game client communicating with a game server;
b. The game client displaying a mahjong table having four player positions to accommodate up to four users who wish to play at the mahjong table, each player position occupied by no more than one user, the mahjong table having a deck of turned down mahjong tiles and a row of turned up mahjong tiles visible to the user at each player position, the row of turned up mahjong tiles being concealed from users occupying the other player positions, the mahjong table having a display portion displaying turned up mahjong tiles which have been discarded by users occupying the player positions;
c. The game client displaying an allow icon to the user at the player position indicating that a viewer desires to view the row of turned up mahjong tiles visible to the user at the player position;
d. the game server configured to link the game client of the viewer to the mahjong table to display the mahjong table to the viewer with the row of turned up mahjong tiles of the player who selected the allow icon being displayed to the viewer.

2. The online mahjong gaming system of claim 1 wherein the game client is configured to allow a requesting user to send a join request to the game server to seat the requesting user at a player position at the mahjong table, the game server being configured to start a hand of mahjong at the mahjong table when at least two player positions are occupied.

3. The online mahjong gaming system of claim 2 wherein the game server is configured to allow additional requesting users to occupy any player positions at the mahjong table which are not already occupied.

4. The online mahjong gaming system of claim 3 wherein the game server is configured to wait until the completion of the hand of mahjong before commencing a new hand of mahjong with the additional requesting users.

5. The online mahjong gaming system of claim 4 wherein the game server is configured to record one of the users occupying the player positions as a first winner of the hand of mahjong and exclude first winner from further play of the hand of mahjong, the game server being further configured to continue the hand of mahjong as a first sub-hand if there are at still users occupying the player positions and if there are still turned down mahjong tiles on the mahjong table, the game server being further configured to record one of the users occupying the payer positions as a second winner of the hand of mahjong and exclude the second winner from further play of the hand of mahjong, the game server being further configured to continue the hand of mahjong as a second sub-hand if there are at still users occupying the player positions and if there are still turned down mahjong tiles on the mahjong table, the game server being further configured to record one of the users occupying the player positions as a third winner of the hand of mahjong and then terminate the hand of mahjong.

6. The online mahjong gaming system of claim 1 wherein the game server is coupled to a database containing personal and identification information for each user, the personal information including a list of other users who are friends, the game server linking the viewer's game client to the mahjong table only if the viewer and the user at the player position who selected the viewer are friends.

7. The online mahjong gaming system of claim 6 wherein the game server and game client are configured to provide a plurality of identical mahjong tables, each mahjong table having a unique identifier, and wherein the game server and game client are configured to identify the mahjong tables where each user's friends are occupying a playing position.

8. The online mahjong gaming system of claim 7 wherein the game server is configured to allow users to exchange messages with their friends.

9. The online mahjong gaming system of claim 8 wherein the game server is configured to allow each user to send a view request to one of the user's friends occupying one of the player positions at one of the mahjong tables, the game server being further configured to link the game client of the user making the view request to the mahjong table of the user's friend so that the user making the view request can view said mahjong table.

10. The online mahjong gaming system of claim 9 wherein the user's friend occupying one of the player positions can activate the allow icon to permit the user making the view request to see the row of upturned mahjong tiles of the user's friend occupying one of the player positions.
